(19) United States
(12) Patent Application Publication
(10) Pub. No.: US 2008/0159627 A1
(43) Pub. Date: Jul. 3, 2008

(54) Part-based pornography detection

(75) Inventor: Srinivasan H. Sengamedu, Bangalore (IN)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/715,155

(22) Filed: Mar. 6, 2007

(30) Foreign Application Priority Data
Dec. 27, 2006 (IN) 2810/DELNP/2006

(51) Int. Cl. G06T 1/00

(52) U.S. Cl. 382/190; 382/224

(57) ABSTRACT

Techniques are described herein for detecting particular body parts in a digital image, and as a result of detecting at least one of these body parts, classifying the digital image as a particular type. According to an embodiment, digital image data that defines a digital image is received as input and the digital image data is analyzed to detect whether the digital image includes one or more specified body parts, such as breasts and/or buttocks. If the digital image is determined to contain one or more of the specified body parts, then the digital image is designated as a first type, such as pornography.

### RELATED APPLICATION DATA

This application is related to and claims the benefit of priority from Indian Patent Application No. 28 10/DELNP/2006, entitled “Part-Based Pornography Detection,” filed Dec. 27, 2006 (Attorney Docket Number 50269-0828), the entire disclosure of which is incorporated by reference as if fully set forth herein.

This application is related to Indian Patent Application No. 2812/DELNP/2006, entitled “Texture Based Pornography Detection,” filed Dec. 27, 2006 (Attorney Docket Number 50269-0860), the entire disclosure of which is incorporated by reference as if fully set forth herein.

This application is related to U.S. patent application Ser. No. ______ (Attorney Docket Number 50269-0857), entitled “Texture Based Pornography Detection,” filed herewith, the entire disclosure of which is incorporated by reference as if fully set forth herein.

This application is related to Indian Patent Application No. 2916/DEL/2005, entitled “Method And Mechanism For Analyzing the Texture of a Digital Image,” filed Oct. 31, 2005 (Attorney Docket Number 50269-0646), the entire disclosure of which is incorporated by reference as if fully set forth herein.

This application is related to U.S. patent application Ser. No. 11/316,728, entitled “Method And Mechanism For Analyzing the Texture of a Digital Image,” filed Dec. 22, 2005 (Attorney Docket Number 50269-0647), the entire disclosure of which is incorporated by reference as if fully set forth herein.

This application is related to Indian Patent Application No. 2918/DEL/2005, entitled “Method And Mechanism For Retrieving Images,” filed Oct. 31, 2005 (Attorney Docket Number 50269-0662), the entire disclosure of which is incorporated by reference as if fully set forth herein.

This application is related to U.S. patent application Ser. No. 11/317,952, entitled “Method And Mechanism for Retrieving Images,” filed Dec. 22, 2005 (Attorney Docket Number 50269-0639), the entire disclosure of which is incorporated by reference as if fully set forth herein.

This application is related to Indian Patent Application No. 897/KOL/2005, entitled “Method And Mechanism For Processing Image Data,” filed Sep. 28, 2005 (Attorney Docket Number 50269-0661), the entire disclosure of which is incorporated by reference as if fully set forth herein.

This application is related to U.S. patent application Ser. No. 11/291,183, entitled “Method And Mechanism for Processing Image Data,” filed Nov. 30, 2005 (Attorney Docket Number 50269-0638, the entire disclosure of which is incorporated by reference as if fully set forth herein.

This application is related to Indian Patent Application No. 2917/DEL/2005, entitled “Method And Mechanism for Analyzing the Color of a Digital Image,” filed Oct. 31, 2005 (Attorney Docket Number 50269-0652), the entire disclosure of which is incorporated by reference as if fully set forth herein.

This application is related to U.S. patent application Ser. No. 11/316,828, entitled “Method And Mechanism for Analyzing the Color of a Digital Image,” filed Dec. 22, 2005 (Attorney Docket Number 50269-0653), the entire disclosure of which is incorporated by reference as if fully set forth herein.

### FIELD OF THE INVENTION

The present invention relates to digital images and, more specifically, to identifying a type of digital image based upon detection of particular body parts displayed in the image.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A digital image is the visual representation of digital image data. Digital image data, similarly, is data that describes how to render a representation of an image. The standards and formats for expressing image data are too numerous to fully mention, but several examples include a GIF file, a JPG file, a PDF file, a BMP file, a TIF file, a DOC file, a TXT file, and a XLS file. [symbol] digital photographs, which are examples of digital images. Further, numerous software applications are available for creating and manipulating various kinds of digital images.

Image retrieval approaches allow users to retrieve a set of digital images that match a set of search criteria. For example, many websites allow a user to submit one or more keywords to a server. The keywords are processed by the server to determine a set of images that are associated with the submitted keywords. The server may then display the matching set of images or thumbnail representations of the set of images, to the user, on a subsequent webpage.

The presence of large numbers of images displaying pornographic and/or offensive content is troublesome in many respects. Users may not want images containing particular unclothed or partially clothed body parts to be displayed in response to a search, because images displaying unclothed or partially clothed body parts such as breasts and buttocks may be indicative of pornographic and/or offensive content. Therefore, techniques exist for adult images to be detected prior to being displayed to a user, particularly in the context of returning search results to a user.

One approach to detecting adult images is for a human to manually view each and every image that may be returned as a result of a search and manually flag an image as containing adult content. This flag would be checked when any image is added to a set of potential search results. As a result, a user can specify that a search should not return images with adult content and images containing the flag will not be displayed.

A drawback to this approach is the tremendous amount of time and effort that must be expended to analyze and flag every image potentially returned in response to an Internet search. It is likely that such an effort would be impossible, given the tremendous amount of image content currently existing on the Internet and the amount added each day.

Another approach to detecting adult images is to identify text associated with a digital image that may indicate a pornographic nature of the digital images. This approach fails where no text exists or where misleading text is associated with the image.

Another approach to detecting adult images prior to returning them in a search result is the use of automated skin-color detection techniques. A drawback to this approach is the large number of false positives and missed detections generated, as the presence of skin in a digital image may simply be a family photograph at a beach instead of a pornographic image. Also, many automated skin-color detection techniques are not effective with black-and-white images.

Thus, approaches for improving the accuracy in detecting adult content in digital images are desirable.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system according to an embodiment of the invention;

FIG. 2 is a block diagram illustrating results of processing digital images according to an embodiment of the invention;

FIG. 3 is a flowchart illustrating the functional steps of detecting a specified body part displayed in a digital image according to an embodiment of the invention; and

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques are discussed herein for detecting particular body parts in a digital image, and as a result of detecting at least one of these body parts, classifying the digital image as a particular type, such as pornographic. Other types are envisioned and the approaches herein should not be construed as being limited to identifying only pornography. A digital image may be considered pornographic not because of skin exposure, but because certain body parts are exposed or partially clothed. For example, a digital image may contain a naked breast. According to an embodiment, digital image data that defines a digital image is received as input and the digital image data is analyzed to detect whether the digital image includes one or more specified body parts, such as breasts and/or buttocks. If the digital image is determined to contain one or more of the specified body parts, then the digital image is designated as a first type, such as pornography. If the digital image does not contain at least one of the specified body parts, then the image is designated as a second type, such as the image contains unknown content, or not pornography, or that a pornographic image was missed because of a strange angle, for example, and the second type may indicate that further analysis is needed, either automatically or manually.

According to an embodiment, digital image data that defines a digital image is received as input and processed by a series of classifiers. According to an embodiment, a classifier is a software process that is configured according to machine learning techniques to identify one particular body part. Each classifier processes the digital image, attempting to identify the one particular body part that the classifier is configured to detect. If at least one of the classifiers detects a particular body part, such as a naked or partially clothed breast, pair of breasts, penis, vagina or buttocks, then the digital image is classified as potentially containing adult content.

According to an embodiment, the digital image is rotated along the horizontal axis before or during the analyzing of the image. For example, the image may be rotated two-dimensionally, flipped along the horizontal axis, flipped along the vertical axis, rotated a specified number of degrees along the horizontal axis and then analyzed, or processed by one or more classifiers, or be analyzed or processed by one or more classifiers during the rotation of the image a full 360 degrees along the horizontal axis. Then, the analyzing and/or processing may be repeated as the image is rotated along the vertical axis or skewed. According to an embodiment, the classifiers may process in the image one at a time or simultaneously. According to an embodiment, as a result of a digital image being identified as potentially a particular type, metadata about the image, such as size of the image, orientation of the image, the particular body part or parts displayed, etc., may be created and associated with the image.

Having described a high level approach of embodiments of the invention, a description of the architecture of an embodiment shall be presented below.

### ARCHITECTURAL OVERVIEW

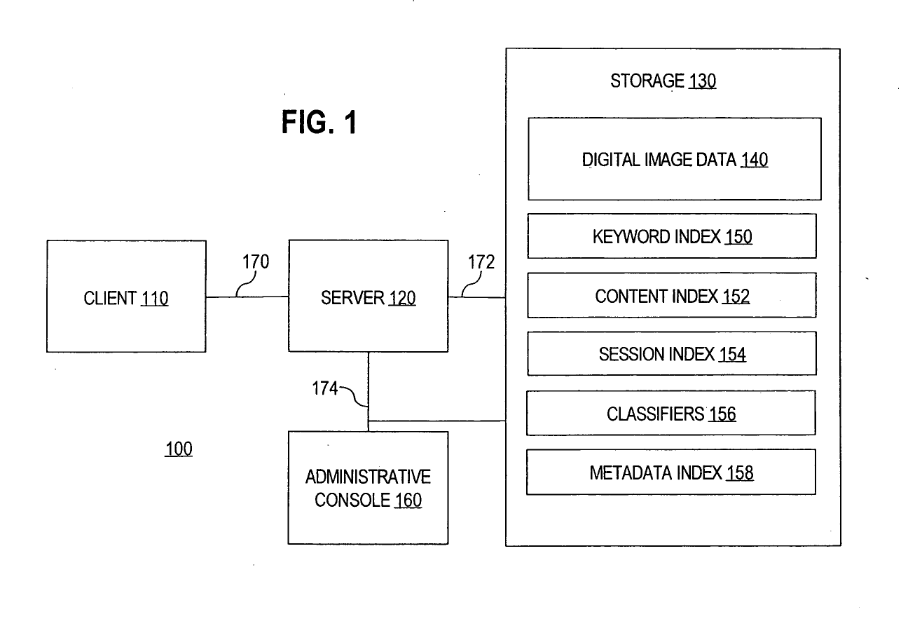

FIG. 1 is a block diagram of a system 100 according to an embodiment of the invention. Embodiments of system 100 may be used to detect digital images that contain adult content by detecting specified body parts displayed in the digital image. According to an embodiment, a user attempts to search for digital images. A user may specify a variety of different search criteria, e.g., a user may specify search criteria that requests the retrieval of digital images that (a) are associated with a set of keywords, and (b) are similar to a base image. As explained below, if the search criteria references a base image, some embodiments of system 100 may also consider which digital images were viewed together with the base image by users in a single session when retrieving the requested digital images.

In the embodiment depicted in FIG. 1, system 100 includes client 110, server 120, storage 130, a plurality of images 140, keyword index 150, a content index 152, a session index 154, a plurality of classifiers 156, a metadata index 158, and an administrative console 160. While client 110, server 120, storage 130, and administrative console 160 are each depicted in FIG. 1 as separate entities, in other embodiments of the invention, two or more of client 110, server 120, storage 130, and administrative console 160 may be implemented on the same computer system. Also, other embodiments of the invention (not depicted in FIG. 1), may lack one or more components depicted in FIG. 1, e.g., certain embodiments may not have a administrative console 160, may lack a session index 154, or may combine one or more of the keyword index 150, the content index 152, and the session index 154 into a single index.

Client 110 may be implemented by any medium or mechanism that provides for sending request data, over communications link 170, to server 120. Request data specifies a request for one or more requested images that satisfy a set of search criteria. For example, request data may specify a request for one or more requested images that are each (a) associated with one or more keywords, and (b) are similar to that of the base image referenced in the request data. The request data may specify a request to retrieve a set of images within the plurality of images 140, stored in or accessible to storage 130, which each satisfy a set of search criteria. The server, after processing the request data, will transmit to client 110 response data that identifies the one or more requested images. In this way, a user may use client 110 to retrieve digital images that match search criteria specified by the user. While only one client 110 is depicted in FIG. 1, other embodiments may employ two or more clients 110, each operationally connected to server 120 via communications link 170, in system 100. Non-limiting, illustrative examples of client 110 include a web browser, a wireless device, a cell phone, a personal computer, a personal digital assistant (PDA), and a software application.

Server 120 may be implemented by any medium or mechanism that provides for receiving request data from client 110, processing the request data, and transmitting response data that identifies the one or more requested images to client 110. Server 120 may also contain a processor for executing instructions comprising the plurality of classifiers 156. A processor for executing instructions comprising the plurality of classifiers 156 may also be implemented as a separate module.

Storage 130 may be implemented by any medium or mechanism that provides for storing data. Non-limiting, illustrative examples of storage 130 include volatile memory, non-volatile memory, a database, a database management system (DBMS), a file server, flash memory, and a hard disk drive (HDD). In the embodiment depicted in FIG. 1, storage 130 stores the digital image data defining a plurality of digital images 140, keyword index 150, content index 152, session index 154, the plurality of classifiers 156, and the metadata index 158. In other embodiments (not depicted in FIG. 1), the image data 140, keyword index 150, content index 152, session index 154, the plurality of classifiers 156, and the metadata index 158 may be stored across two or more separate locations, such as two or more storages 130.

Image data 140 represent images that the client 110 may request to view or obtain. Keyword index 150 is an index that may be used to determine which digital images, of a plurality of digital images, are associated with a particular keyword. Content index 152 is an index that may be used to determine which digital images, of a plurality of digital images, are similar to that of a base image. A base image, identified in the request data, may or may not be a member of the image data 140. Session index 154 is an index that may be used to determine which digital images, of a plurality of digital images, were viewed together with the base image by users in a single session. The plurality of classifiers 156 are software modules, or sets of instructions, that when executed perform steps as described herein. The plurality of classifiers 156 may be stored in computer memory, in one file or in several files. According to an embodiment, a classifier is a software program that is constructed for the purpose of classifying input objects into a set of categories. The categories are specified during a construction phase of the classifier called the training phase and the process of classifier construction is called training. During the training phase, exemplary objects for each of the various object categories are given to the classifier and the classifier “learns” the characteristic properties of the objects belonging to each category that would help the classifier in the classification process. A classifier is said to have good generalization property if the classifier is able to categorize objects not seen by it by far into their correct categories, making very few errors in the process.

Administrative console 160 may be implemented by any medium or mechanism for performing administrative activities in system 100. For example, in an embodiment, administrative console 160 presents an interface to an administrator, which the administrator may use to add digital images to the image data 140, remove digital images from the digital image data 140, create an index (such as keyword index 150, content index 152, session index 154, or metadata index 158) on storage 130, or configure the operation of server 120 or the plurality of classifiers 156.

Communications link 170 may be implemented by any medium or mechanism that provides for the exchange of data between client 110 and server 120. Communications link 172 may be implemented by any medium or mechanism that provides for the exchange of data between server 120 and storage 130. Communications link 174 may be implemented by any medium or mechanism that provides for the exchange of data between administrative console 160, server 120, and storage 130. Examples of communications links 170, 172, and 174 include, without limitation, a network such as a Local Area Network (LAN), Wide Area Network (WAN), Ethernet or the Internet, or one or more terrestrial, satellite or wireless links.

### Part-Based Pornography Detection

According to an embodiment, digital image data that defines a digital image is received as input and the digital image data is analyzed to detect whether the digital image includes one or more specified body parts, such as breasts and/or buttocks. If the digital image is determined to contain one or more of the specified body parts, then the digital image is designated as a first type, such as pornography. If the digital image does not contain at least one of the specified body parts, then the image is designated as a second type, such as the image contains unknown content, or not pornography.

According to an embodiment, one or more classifiers are provided that accept digital image data as input and determine whether one or more specific body parts are displayed in an image. According to an embodiment, the classifiers are software programs or instructions capable of being executed by a computer processor. A classifier is “trained” by taking a set of digital images known to contain a particular body part, for example a breast, using these images as input to the classifier, and using machine learning techniques to train the classifier to identify similar aspects of other images. A control set of images known not to contain breasts may also be used to train the classifier. After training the classifier, given a new image, the classifier is able to utilize aspects of the teaching input to detect the potential presence of a breast in the new image. The new image may be input by a user, or obtained from a web page where it is displayed, as part of an indexing process.

According to an embodiment, one classifier is used for one specified body part. For example, there may be a classifier to identify a single breast, a classifier to identify a pair of breasts, a classifier to identify a penis, a classifier to identify a vagina, a classifier to identify a single buttock, and/or a classifier to identify a pair of buttocks. According to an embodiment, one classifier is capable of detecting more than one body part. According to an embodiment, the classifier may be trained to identify body parts that are unclothed or partially clothed, and whether the display of a partially clothed body part qualifies an image as a particular type may be defined by a user or contained in the instructions comprising the classifier.

According to an embodiment, the image is processed in sequential order by one or more classifiers, while other embodiments are envisioned where multiple classifiers process the digital image simultaneously. As a result of the processing, if one or more of the classifiers detects in the image the particular body part the classifier is trained to detect, then the image is identified as potentially being a particular type such as pornographic, offensive, containing adult content, or being an adult image. According to an embodiment, an image identified as “pornographic” is also identified as “offensive,” while an image identified as “offensive” may not be identified as “pornographic.” According to an embodiment, if a classifier detects a particular body part in an image, the image is defined as pornographic. According to an embodiment, a level of “offensiveness” of an image may be described by the nature of body parts detected, the sizes of the body parts detected, and/or the amount of skin detected in an image. If none of the classifiers detect the particular body part in an image, then the image may be marked as “unknown” or identified as not displaying pornographic content.

Because body parts may have a different appearance depending on the angle they are displayed in an image, an embodiment rotates the image along the horizontal and/or vertical axis prior to analyzing or processing by one or more classifiers. According to an embodiment, an image is flipped or rotated along a first axis and then analyzed and/or processed by one or more classifiers. If the particular body part is not detected, then the image is flipped or rotated along a second axis and then processed again. As an example, an image may be rotated along the horizontal axis a specified number of degrees and then analyzed for a particular body part. If the body part is not found, then the image is rotated along a vertical axis, such as skewing the image, and then scanned. According to an embodiment, image data is scanned for a particular body part by one or more classifiers as it is being rotated, while other embodiments envision rotating the image a specified number of degrees and scanning the image after rotation is completed. According to an embodiment, body parts positioned at various angles may be detected, thereby eliminating the need for image rotation. For example, a classifier may be configured to detect a breast disposed at 45 degrees, or a classifier may be configured to detect a side view of one or more buttocks. According to an embodiment, the angle of rotation of a region is estimated and the rotation is offset before processing by the classifier.

According to an embodiment, the classifier utilizes the Viola-Jones approach to object detection, as described in Viola, P and Jones, M, “Rapid Object Detection Using a Boosted Cascade of Simple Features,” IEEE Computer Society Conference on Computer Vision and Pattern Recognition (CVPR), Vol. 1, pp. 511-518, 2001. According to an embodiment, an image may be subdivided into subimages prior to processing. For example, a 100×100 image may be divided into all possible subimages of all sizes, each resized into 20×20 subimages and these resized subimages processed by the one or more classifiers.

According to an embodiment, the digital image data defining a digital image is analyzed and assigned an alphanumerical value, or score, based on the analysis. The score may represent the presence of one or more specified body parts displayed in the digital image, the presence of and/or amount of skin displayed in the image, and/or the size of the one or more specified body parts displayed in the digital image, among other factors. The score may then be compared to a threshold value or score representing an image of a particular type, and based on the comparison, the digital image data is designated as a particular type.

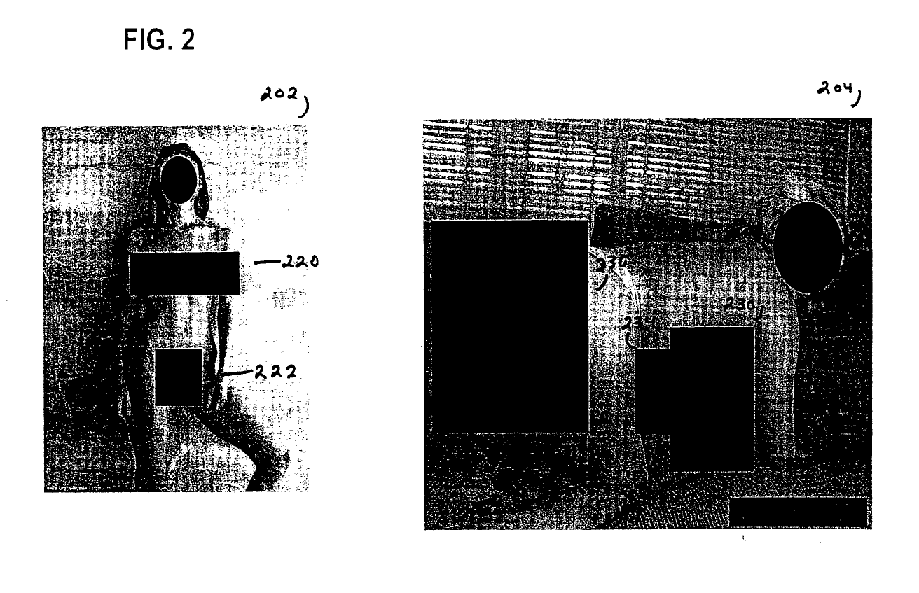

FIG. 2 is a block diagram 200 illustrating sample results of processing digital images according to an embodiment of the invention. In FIG. 2, two digital images 202, 204 have been downloaded as part of an approach for indexing digital images. According to an embodiment, the digital images 202, 204 are resized to 100 by 100 pixels, or another specified size, in order to reduce the number of pixels to be processed in the digital image.

According to an embodiment, the digital images 202, 204 are received as input, for example, to index for future inclusion in search results. One or more classifiers, wherein the classifiers are configured to identify a particular body part as described above, process the digital image data to detect a specified body part. In an image 202 in FIG. 2, two body parts are detected in the image: a pair of breasts and a vagina. The solid rectangles 220, 222 demonstrate the area of the image detected by the classifiers as displaying the particular body part. According to an embodiment, the classifier trained to detect breasts would identify the display of breasts 220 and the classifier trained to detect vaginal displays would detect the display of a vagina 222. In FIG. 2, these rectangles are displayed as solid squares and obfuscated to sanitize the image for purposes of the application. The appearance of the rectangles is for illustration purposes only and should not be construed to limit the approaches to a single embodiment.

In another image 204 in FIG. 2, three body parts are detected in the image 204: two breasts and a set of buttocks. The solid rectangles 230, 232, 234 demonstrate the area of the image detected by the classifiers as displaying the particular body part. According to an embodiment, the classifier trained to detect breasts would identify the display of single breasts 230, 232 and the classifier trained to detect buttocks would detect the display of buttocks 234. In FIG. 2, these rectangles are displayed as solid squares and obfuscated to sanitize the image for purposes of the application. The appearance of the rectangles is for illustration purposes only and should not be construed to limit the approached to a single embodiment.

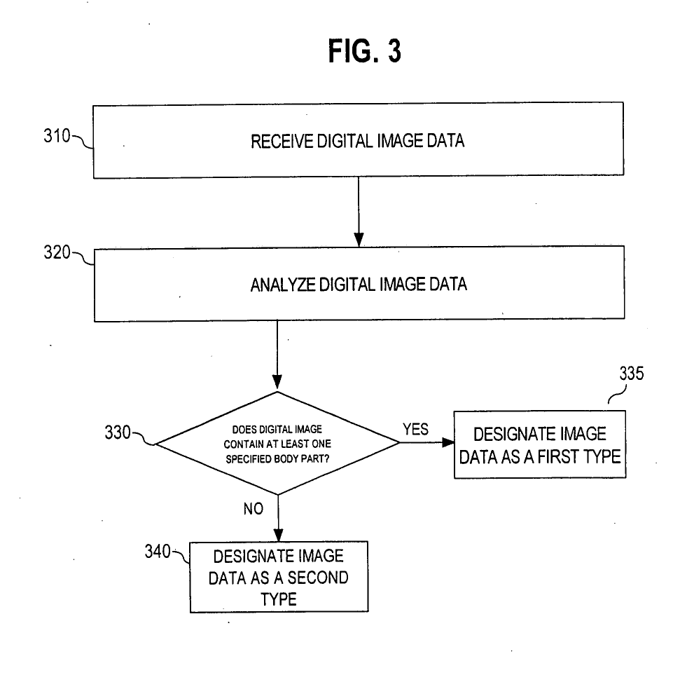

FIG. 3 is a flowchart illustrating the functional steps of detecting a specified body part displayed in a digital image according to an embodiment of the invention. In step 310, digital image data, which may be uploaded by a user, or obtained from a web page, or subsequently downloaded, for example as part of an indexing approach, is received as input. According to an embodiment, the input is received by a system comprising one or more image classifiers as described herein. In step 320, the digital image data is analyzed to detect the presence of a particular body part in the digital image defined by the digital image data. In step 330, if the digital image includes at least one specified body part, then in step 335 the image data is designated as a first type, such as potentially pornographic, offensive, and/or adult in nature. In step 340, if the digital image does not include at least one specified body part, then the digital image data is designated as a second type, such as “unknown” or not pornographic. Other types are envisioned in addition to a first and second type, as any number of types may be defined.

According to an embodiment, the above approach may be used as a prioritization tool for an editorial screening process for identifying images not suitable for a “SafeSearch” mode in which offensive images are not supposed to appear in Internet search results. In one mode of operation, all images to be screened are shown to human editors and the editors mark each image as adult or non-adult after viewing the image. The approaches described herein process the images before they are shown to the editors. Depending on the presence of selected body parts and other cues, some of the images may be identified as “potentially adult.” According to an embodiment, only those images identified as “potentially adult” are shown to the editors for final confirmation. This is done to increase the accuracy of classification. In another embodiment, only those images identified as “potentially non-adult” are shown to the editors. This is done to increase the coverage of classification.

### Hardware Overview

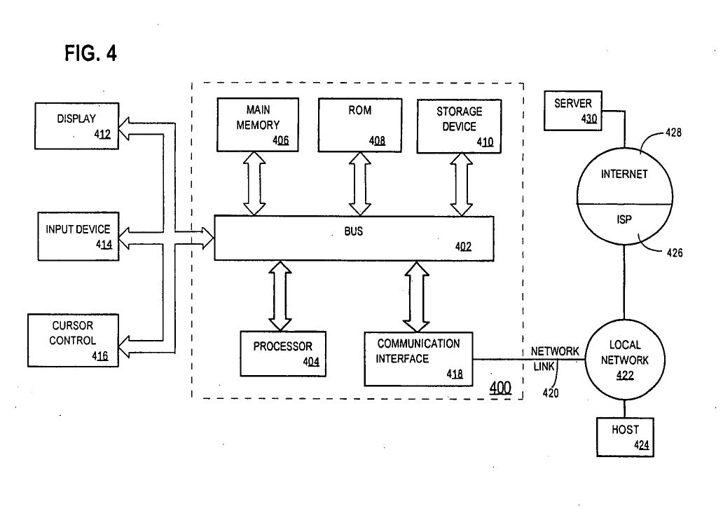

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the-invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for identifying pornographic images, the computer-implemented method comprising:
receiving digital image data that defines a digital image;
analyzing the digital image data to detect whether the digital image includes one or more specified body parts;
if the digital image includes at least one of the one or more specified body parts, then designating the digital image data as a first type;
if the digital image does not include at least one of the one or more specified body parts, then designating the digital image data as a second type.

2. The computer-implemented method of claim 1 wherein the first type designates pornography.

3. The computer-implemented method of claim 1 wherein the second type designates non-pornography.

4. The computer-implemented method of claim 1 wherein the second type designates an unknown type.

5. The computer-implemented method of claim 1 wherein the digital image data is obtained from one or more web pages.

6. The computer-implemented method of claim 1 further comprising resizing the digital image prior to analyzing the digital image data.

7. The computer-implemented method of claim 1 wherein analyzing the digital image data includes:
rotating the digital image along a first axis;
detecting whether a specified body part is included in the digital image data by analyzing the rotated digital image;
if none of the specified body parts are included in the rotated digital image data, then rotating the digital image along a second axis; and
detecting whether a specified body part is included in the digital image data by analyzing the rotated digital image.

8. The computer-implemented method of claim 7 wherein detecting whether a specified body part is includes in the digital image data by analyzing the rotated digital image includes analyzing the digital image after the rotation is completed.

9. The computer-implemented method of claim 7 wherein detecting whether a specified body part is includes in the digital image data by analyzing the rotated digital image includes analyzing the digital image during the rotation.

10. The computer-implemented method of claim 1 further comprising:
determining the size of the one or more specified body parts;
if the size of the one or more specified body parts does not exceed a threshold value, then designating the digital image data as a second type.

11. The computer-implemented method of claim 1 further comprising:
assigning a score to the digital image data as a result of the analysis;
comparing the score to a predetermined value;
as a result of the comparison, designating the digital image data as a particular type.

12. The computer-implemented method of claim 1 wherein the specified body part is one of: breast, pair of breasts, penis, vagina, or buttocks.

13. The computer-implemented method of claim 12 wherein the specified body part is partially clothed.

14. A computer-readable medium carrying instructions which, when executed by one or more processors, causes:
receiving data that defines a digital image;
analyzing the digital image data to detect whether the digital image includes one or more specified body parts;
if the digital image includes at least one of the one or more specified body parts, then designating the digital image data as a first type;
if the digital image does not include at least one of the one or more specified body parts, then designating the digital image data as a second type.

15. A computer-readable medium carrying one or more sequences of instructions which, when executed by one or more processors, causes the one or more processors to perform the method recited in claim 2.

16. A computer-readable medium carrying one or more sequences of instructions which, when executed by one or more processors, causes the one or more processors to perform the method recited in claim 3.

17. A computer-readable medium carrying one or more sequences of instructions which, when executed by one or more processors, causes the one or more processors to perform the method recited in claim 4.

18. A computer-readable medium carrying one or more sequences of instructions which, when executed by one or more processors, causes the one or more processors to perform the method recited in claim 5.

19. A computer-readable medium carrying one or more sequences of instructions which, when executed by one or more processors, causes the one or more processors to perform the method recited in claim 6.

20. A computer-readable medium carrying one or more sequences of instructions which, when executed by one or more processors, causes the one or more processors to perform the method recited in claim 7.

21. A computer-readable medium carrying one or more sequences of instructions which, when executed by one or more processors, causes the one or more processors to perform the method recited in claim 8.

22. A computer-readable medium carrying one or more sequences of instructions which, when executed by one or more processors, causes the one or more processors to perform the method recited in claim 9.

23. A computer-readable medium carrying one or more sequences of instructions which, when executed by one or more processors, causes the one or more processors to perform the method recited in claim 10.

24. A computer-readable medium carrying one or more sequences of instructions which, when executed by one or more processors, causes the one or more processors to perform the method recited in claim 11.

25. A computer-readable medium carrying one or more sequences of instructions which, when executed by one or more processors, causes the one or more processors to perform the method recited in claim 12.

26. A computer-readable medium carrying one or more sequences of instructions which, when executed by one or more processors, causes the one or more processors to perform the method recited in claim 13.

27. An apparatus for retrieving digital images, comprising:
a machine-readable medium carrying one or more sequences of instructions; and
one or more processors, wherein execution of the one or more sequences of instructions by the one or more processors causes:
receiving as input digital image data defining a digital image;
processing, by a first classifier, the digital image data, wherein the first classifier is configured to detect whether the digital image includes one or more specified body parts;
processing, by a second classifier, the digital image data, wherein the second classifier is configured to detect whether the digital image includes one or more specified body parts that are different from the one or more specified body parts the first classifier is configured to detect;
if one or more of the classifiers detect that the digital image contains at least one of the one or more specified body parts, then designating the digital image data as a first type;
if none of the classifiers detect that the digital image contains at least one of the one or more specified body parts, then designating the digital image data as a second type.

28. The apparatus of claim 27 wherein the classifiers process in sequential order the digital image data.

29. The apparatus of claim 27 wherein the classifiers simultaneously process the digital image.

30. The apparatus of claim 27 further comprising one or more sequences of instructions, wherein execution of the one or more sequences of instructions by the one or more processors causes:
if one or more of the classifiers detect a specified body part displayed in the digital image, then creating metadata identifying the digital image data as a particular type; and
associating the metadata with the digital image data.

31. The method of claim 27 wherein at least one classifier is configured to detect more than one specified body part.
